(19) United States
(12) Patent Application Publication
(10) Pub. No.: US 2016/0007806 A1
(43) Pub. Date: Jan. 14, 2016

(54) SNACK TRAY ASSEMBLY

(71) Applicant: TARGET BRANDS, INC., Minneapolis, MN (US)

(72) Inventors: Kellie A. Rosen, Chaska, MN (US); Carla M. Zidarevich, Minneapolis, MN (US)

(21) Appl. No.: 14/330,246

(22) Filed: Jul. 14, 2014

(51) Int. Cl. A47J 47/14; B31B 3/26

(52) U.S. Cl. CPC A47J 47/14; B31B 3/26

(57) ABSTRACT

A snack tray assembly includes snack and condiment holders. The snack holder has a receptacle defined by a bottom and a plurality of sides and a condiment flap having an upper surface, an opposing lower surface, a fixed end coupled to the top of one of the plurality of sides, at least one free end and an opening that extends from the upper surface to the lower surface. The condiment holder is defined by a bottom and a plurality of sides. The opening in the condiment flap of the snack holder receives and holds the condiment holder so that a first portion of the condiment holder is protruding substantially upward from the upper surface of the condiment flap and a second portion of the condiment holder is protruding substantially downward from the lower surface of the condiment flap.

### BACKGROUND

Disposable food packages are used by fast food restaurants, takeout restaurants, food vendor kiosks and family residences for holding and serving food. Exemplary disposable food packages include plates, bowls, cups, utensils and trays and can be made out of various types of disposable materials such as paper, plastic, bio-resin, etc.

The discussion above is merely provided for general background information and is not intended to be used as an aid in determining the scope of the claimed subject matter.

### SUMMARY

A snack tray assembly includes a snack holder and a condiment holder. The snack holder has a receptacle defined by a bottom and a plurality of sides. Each of the plurality of sides extends from the bottom of the receptacle to a top of the receptacle. The receptacle also includes a condiment flap having an upper surface, an opposing lower surface, a fixed end coupled to the top of one of the plurality of sides, at least one free end and an opening that extends from the upper surface to the lower surface. The opening is spaced apart from the fixed end and from the at least one free end. The condiment holder is defined by a bottom and a plurality of sides. Each of the plurality of sides extends from the bottom of the condiment holder to a top end of the condiment holder. The opening in the condiment flap of the snack holder receives and holds the condiment holder so that a first portion of the condiment holder is protruding substantially upward from the upper surface of the condiment flap and a second portion of the condiment holder is protruding substantially downward from the lower surface of the condiment flap.

A snack tray assembly includes a first sheet material that is formable into a primary container. The first sheet material includes a first bend spaced apart from a first free edge such that the first free edge and the first bend define a back panel, a second bend spaced apart from the first bend such that the first bend and the second bend define a first side panel, a third bend spaced apart from the second bend such that the second bend and the third bend define a front panel, a fourth bend spaced apart from the third bend such that the third bend and the fourth bend define a second side panel and a support panel coupled to one of the back panel, the front panel, the first side panel and the second side panel by a top bend that defines a top of one of the back panel, the front panel, the first side panel and the second side panel. The support panel includes a through hole. A second sheet material is formable into a secondary container. The secondary container being partially inserted into and held in the through hole in the support panel of the first sheet material.

A method of assembling a snack tray includes forming a first sheet material into a snack holder having a receptacle and a condiment flap. A second sheet material is formed into a condiment holder. The condiment holder is inserted into an opening in the condiment flap of the snack holder so that a first portion of the condiment holder is protruding substantially upward from an upper surface of the condiment flap and a second portion of the condiment holder is protruding substantially downward from a lower surface of the condiment flap.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a plan view of a first sheet material formable into a snack holder of a snack tray assembly according to one embodiment.

FIG. 2 is a plan view of a second sheet material formable into a condiment holder of a snack tray assembly according to one embodiment.

FIG. 3 is an exploded view of a snack tray assembly including the snack holder of FIG. 1 as assembled and the condiment holder of FIG. 2 as assembled.

FIG. 4 is an assembled, perspective view of the snack tray assembly illustrated in FIG. 3.

FIG. 5 is a front view of the snack tray assembly illustrated in FIG. 4.

FIG. 6 is a back view of the snack tray assembly illustrated in FIG. 4.

FIG. 7 is left side view of the snack tray assembly illustrated in FIG. 4.

FIG. 8 is a right side view of the snack tray assembly illustrated in FIG. 4.

FIG. 9 is a top view of a top view of the snack tray assembly illustrated in FIG. 4.

FIG. 10 is a bottom view of the snack tray assembly illustrated in FIG. 4.

### DETAILED DESCRIPTION

Many snack foods, such as crackers, chips, pretzels, wings, fries, etc., are consumed with an associated condiment or sauce for enhancing or complimenting the snack. For example, any of the above-listed snacks can be eaten with a dip or sauce, such as salsa, melted cheese, ketchup and various types of dressings. One way to serve these types of snacks is with a disposable tray having two molded compartments made out of plastic so that the snack sits separate from the condiment. The larger of the two compartments holds the snack and the smaller of the two compartments holds the condiment. However, these disposable plastic trays are bulky and cannot be easily broken down or collapsed for disposal.

As will be described in detail below, a snack tray assembly includes a first sheet material formable into a snack holder and a second sheet material formable into a condiment holder. The snack holder has a receptacle and a flap that extends from a top of the receptacle. The flap includes a through hole or opening. The condiment holder is inserted through and held in the opening in the flap so that a first portion of the condiment holder protrudes upwardly from an upper surface of the flap and a second portion of the condiment holder protrudes downwardly from a lower surface of the flap.

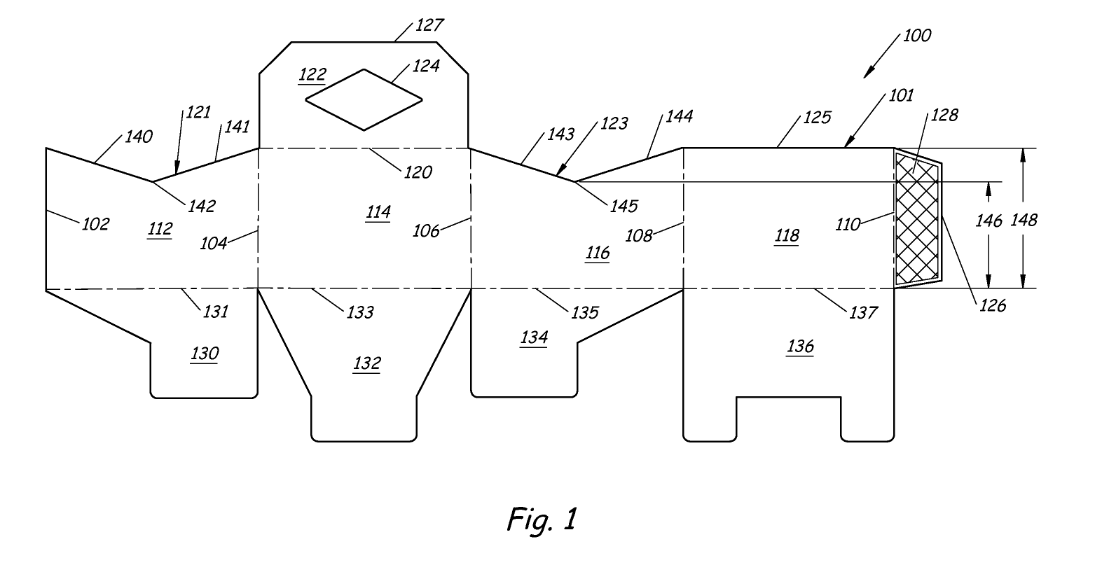

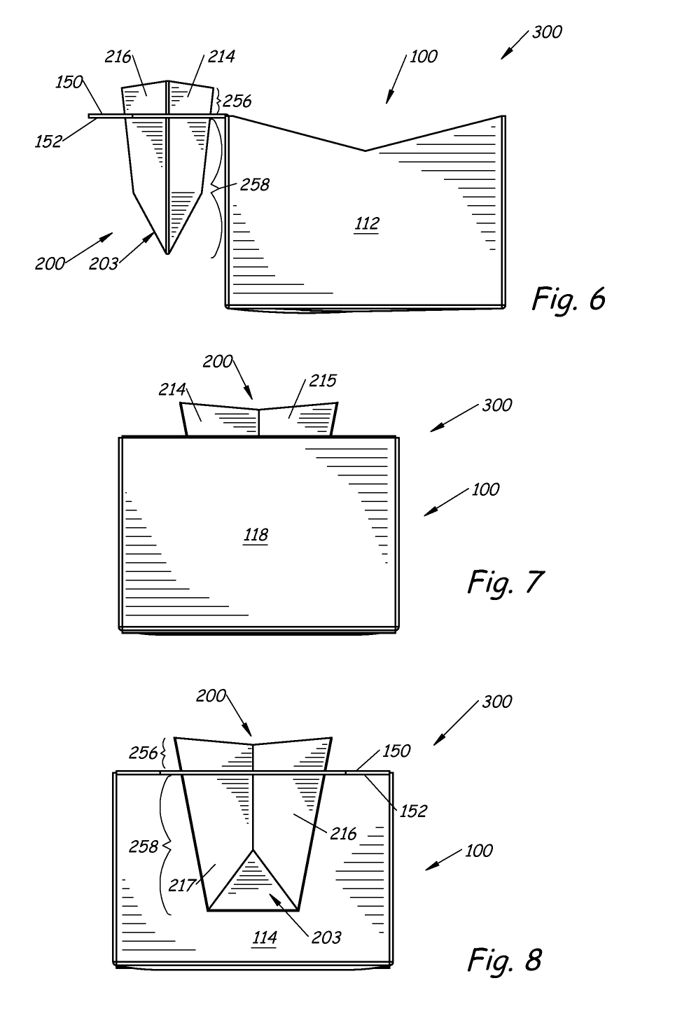

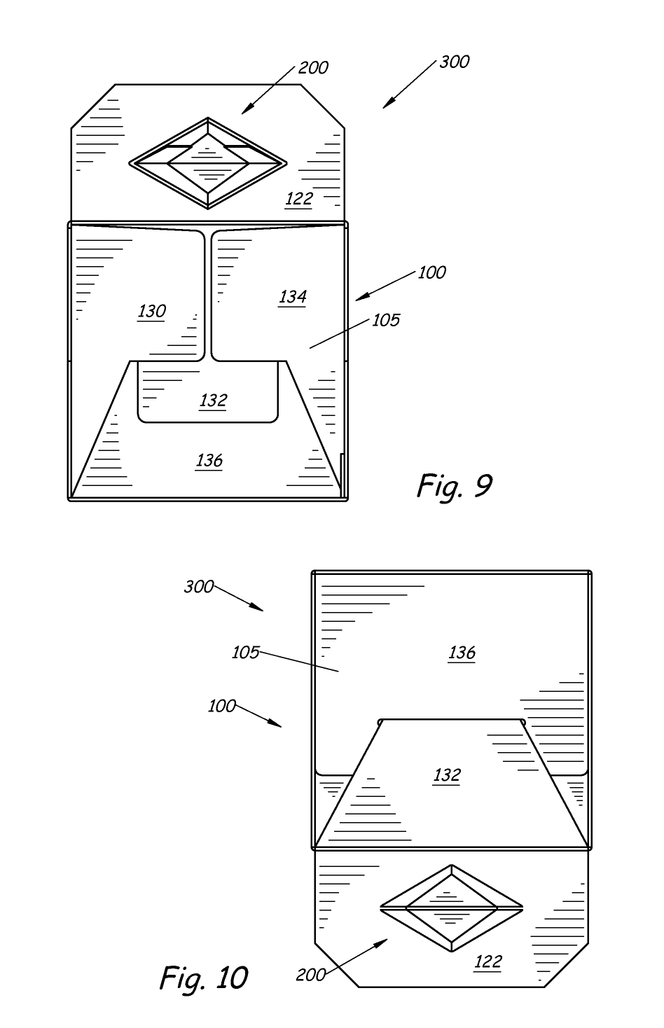

FIG. 1 is a plan view of a first sheet material 101 formable into a snack holder or primary container 100 of a snack tray assembly 300 (FIGS. 3-9) according to one embodiment. First sheet material 101 is a single, continuous piece of sheet material and includes a first free edge 102, a first score or bend 104, a second score or bend 106, a third score or bend 108 and a fourth score or bend 110. First score 104 is spaced apart from and substantially parallel with first free edge 102 such that first free edge 102 and first score 104 define a back panel 112 of a receptacle 103 (FIGS. 3-9) of snack holder 100. Second score 106 is spaced apart from and substantially parallel with first score 104 such that first score 104 and second score 106 define a first side panel 114 of receptacle 103. Third score 108 is spaced apart from and substantially parallel with second score 106 such that second score 106 and third score 108 define a front panel 116 of receptacle 103. Fourth score 110 is spaced apart from and substantially parallel with third score 108 such that third score 108 and fourth score 110 define a second side panel 118.

First sheet material 101 includes a second free edge 126 spaced apart from and substantially parallel with fourth score 110 such that fourth score and second free edge 126 define a glue flap 128. First sheet material 101 also includes a top score 120 substantially perpendicular to first free edge 102, first score 104, second score 106, third score 108 and fourth score 110. Top score 120 defines a top of one of back panel 112, first side panel 114, front panel 116 and second side panel 118 and top ends of the remainder of back panel 112, first side panel 114, front panel 116 and second side panel 118 that are not defined by top score 120 include free edges. In the embodiment illustrated in FIG. 1, top score defines a top of first side panel 114. Therefore, the top end of back panel 112 is defined by a free edge 121, the top end of front panel 116 is defined by a free edge 123 and the top end of second side panel 118 is defined by a free edge 125.

Spaced apart from and substantially parallel with top score 120 is a free edge 127. Defined between free edge 127 and top score 120 is condiment flap or support panel 122. In the embodiment illustrated in FIG. 1, top score 120 couples condiment flap or support panel 122 to first side panel 114. Condiment flap 122 includes an opening or through hole 124 for receiving and holding a condiment holder. The condiment holder and opening 124 will be discussed in more detail below.

Still further, first sheet material 101 includes a plurality of bottom panels 130, 132, 134 and 136. Each bottom panel 130, 132, 134 and 136 is coupled to one of back panel 112, first side panel 114, front panel 116 and second side panel 118 by bottom scores 131, 133, 135 and 137. For example and as illustrated in the FIG. 1 embodiment, bottom panel 130 is coupled to back panel 112 by bottom score 131, bottom panel 132 is coupled to first side panel 114 by bottom score 133, bottom panel 134 is coupled to front panel 116 by bottom score 135 and bottom panel 136 is coupled to second side panel 118.

As illustrated in FIG. 1, free edge 121 of the top end of back panel 112 and free edge 123 of the top end of front panel 116 are out of alignment with top score 120 and out of alignment with free edge 125 of second side panel 118. More specifically, free edge 121 includes a first portion 140 and a second portion 141. First portion 140 extends from first free edge 102 to a midpoint 142 (i.e., a central point that is in the center of free edge 121) and second portion 141 extends from midpoint 142 to first score 104. Free edge 123 includes a first portion 143 and a second portion 144. First portion 143 extends from second score 106 to a midpoint 145 (i.e., a central point that is in the center of free edge 123) and second portion 144 extends from midpoint 145 to third score 108. Midpoint 142 of free edge 121 and midpoint 145 of free edge 123 includes a height 146 relative to bottom scores 131, 133, 135 and 137 that is less than height 148 of top score 120 of first side panel 114 and free edge 125 of second side panel 118 relative to bottom scores 131, 133, 135 and 137.

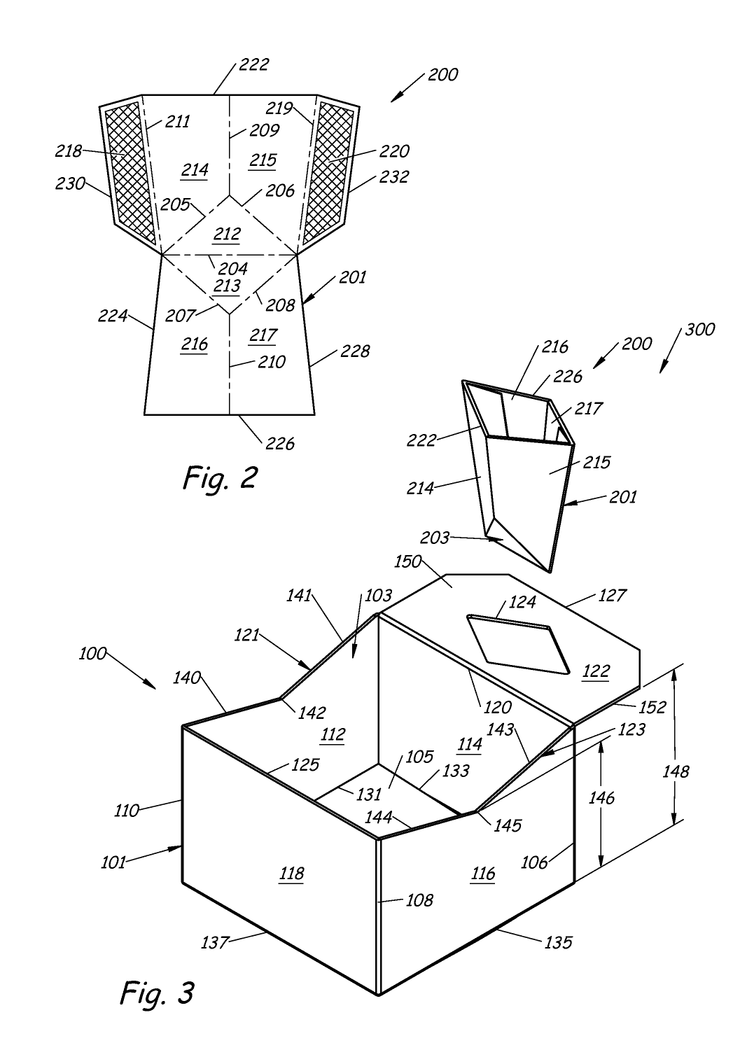

FIG. 2 is a plan view of a second sheet material 201 formable into a condiment holder or secondary container 200 of snack tray assembly 300 (FIGS. 3-9) according to one embodiment. Second sheet material 201 is a single, continuous piece of sheet material and includes a first bottom panel 212, a second bottom panel 213, a first side panel 214, a second side panel 215, a third side panel 216 and a fourth side panel 217.

A first score or bend 204 couples first bottom panel 212 to second bottom panel 213. First bottom panel 212 is defined by first score 204, a second score or bend 205 and a third score or bend 206 and second bottom panel 213 is defined by first score 204, a fourth score or bend 207 and a fifth score or bend 208. Second score 205 is substantially parallel to fifth score 208 and couples first side panel 214 to first bottom panel 212. Third score 206 is substantially parallel to third score 207 and couples second side panel 215 to first bottom panel 212. Fourth score 207 couples third side panel 216 to second bottom panel 213. Fifth score 208 couples fourth side panel 217 to second bottom panel 213.

A sixth score 209 couples first side panel 214 to second side panel 215 and a seventh score 210 couples third side panel 216 to fourth side panel 217. An eighth score 211 couples first side panel 214 to a first glue flap 218 and a ninth score 219 couples second side panel 215 to a second glue flap 220. Therefore, first side panel 214 is defined by second score 205, sixth score 209, eighth score 211 and a first free top end 222. Second side panel 215 is defined by third score 206, sixth score 209, ninth score 219 and first free top end 222. Third side panel 216 is defined by fourth score 207, seventh score 210, a free side end 224 and a second free top end 226. Fourth side panel 217 is defined by fifth score 208, seventh score 210, a free side end 228 and second free top end 226. First free top end 222 and second free top end 226 are substantially parallel with each other. First glue flap 218 is defined by eighth score 211 and a free side end 230 and second glue flap 220 is defined by ninth score 219 and a free side end 232.

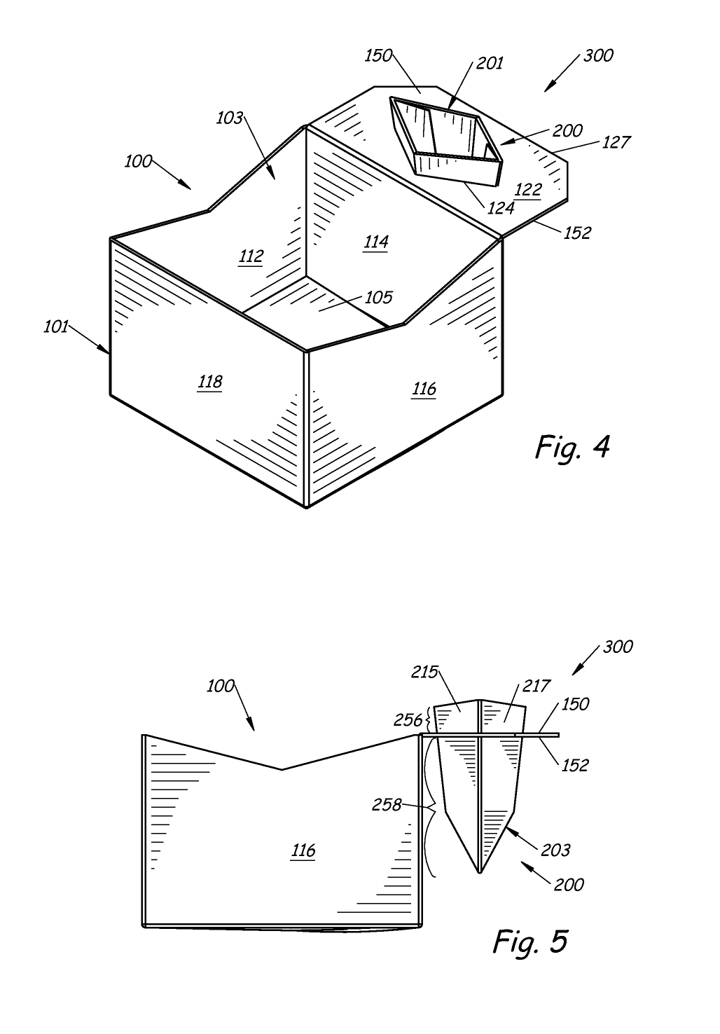

FIG. 3 is an exploded view of snack tray assembly 300 including first sheet material 101 formed into snack holder or primary container 100 of FIG. 1 and second sheet material 201 formed into condiment holder or secondary container 200 of FIG. 2. FIG. 4 is a perspective view of snack tray assembly 300 illustrated in FIG. 3 as assembled. FIGS. 5-10 are front, back, left side, right side, top and bottom views of snack tray assembly 300 as illustrated in FIG. 4.

Snack holder 100 includes receptacle 103 and condiment flap 122. To form snack holder 100, first sheet material 101 is bent at first score 104, second score 106, third score 108, fourth score 110 and bottom scores 131, 133, 135 and 137. Bottoms panels 130, 132, 134 and 136 are assembled together into a secured configuration to form a bottom 105 of receptacle 103. Glue flap 128 is adhesively coupled to back panel 112 to place second side panel 118 adjacent to back panel 112 to form a plurality of sides of receptacle 103, which include back panel 112, first side panel 114, front panel 116 and second side panel 118. Finally, condiment flap 122 is bent at top score 120 to form the support panel for condiment holder 200.

Each of the plurality of sides (112, 114, 116 and 118) extend from bottom 105 to a top of receptacle 103. The top of receptacle 103 includes free edge 121, top score 120, free edge 123 and free edge 125. As previously described, midpoint 142 of free edge 121 and midpoint 145 of free edge 123 includes a height 146 relative to bottom 105 of receptacle that is less than height 148 of top score 120 of first side panel 114 and free edge 125 of second side panel 118 relative to bottom 105. By free edge 121 and free edge 123 being out of alignment from top score 120 and free edge 125, food that is placed in receptacle 103 can be easily accessed.

Condiment flap or support panel 122 includes an upper surface 150, an opposing lower surface 152, a fixed end (i.e., top score 120) that couples to the top of one of the plurality of sides, at least one free end 127 and an opening or through hole 124 that extends from upper surface 150 to lower surface 152. Opening 124 is spaced apart from the fixed end (i.e., top score 120) and from the at least one free end 127.

To form condiment holder or secondary container 200, second sheet material 201 is bent at first, second, third, fourth, fifth, sixth, seventh, eighth and ninth scores 204-211 and 219. By bending first, second, third, fourth and fifth scores 204-208, a bottom 203 of condiment holder 200 is formed. First glue flap 218 is adhesively coupled to third side panel 216 to place third side panel 216 adjacent to first side panel 214 and second glue flap 220 is adhesively coupled to fourth side panel 217 to place fourth side panel 217 adjacent to second side panel 215. Attaching first and second glue flaps 218 and 220 to side panels 216 and 217, respectively, forms a plurality of sides of condiment holder 200, which include first, second, third and fourth side panels 214-217.

Each of the plurality of sides (214-217) of condiment holder 200 extend from bottom 203 to a top of condiment holder 200. The top of condiment holder 200 includes first free top end 222 and second free top end 226. Together bottom 203, sides 214-217 and free top ends 222 and 226 provide a container or vessel for holding a condiment, such as a sauce. Condiment holder 200 is constructed as such to be able to prevent sauces from leaking because bottom 203 is one integral piece that integrally couples to side panels 214-217 by at least one bend that defines bottom 203. In addition, free side end 224 of side panel 216 and free side end 228 of side panel 217 are sealed to glue flaps 218 and 220, respectively to further prevent leakage.

Condiment holder 200 is inserted into opening or through hole 124 (e.g., opening or through hole 124 receives condiment holder 200) in condiment flap or support panel 222 of snack holder 100 so that a first portion 256 of condiment holder 200 is protruding substantially upward from upper surface 150 of condiment flap 122 and a second portion 258 of condiment holder 200 is protruding substantially downward from lower surface 152 of condiment flap 122. Bottom 203 of condiment holder 200 (i.e., first bottom panel 212 and second bottom panel 213) and lower portions of first side panel 214, second side panel 215, third side panel 216 and fourth side panel 217 are located below condiment flap or support panel 122 of snack holder 100 when condiment holder 200 is located in opening or through hole 124 and upper portions of first side panel 214, second side panel 215, third side panel 216 and fourth side panel 217 are located above condiment flap or support panel 122 when condiment holder 200 is located in opening or through hole 124.

Still further, bends 211 and 219 and free ends 224 and 228 of condiment holder 200 are oriented relative to first free top end 222 and second free top end 226 at angles or are tapered so that bottom has a width dimension that is less than a width dimension of free top ends 222 and 226. In this way, the tapered shape of condiment holder 200 keeps condiment holder 200 from falling through opening 224 when it is inserted through opening 224. In other words, the width dimension of bottom 203 is less than a width dimension of opening 224, but the dimension of free top ends 222 and 226 is greater than the width dimension of opening 224.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A snack tray assembly comprising;
a snack holder comprising:
a receptacle defined by a bottom and a plurality of sides, each of the plurality of sides extending from the bottom of the receptacle to a top of the receptacle;
a condiment flap having an upper surface, an opposing lower surface, a fixed end that couples to the top of one of the plurality of sides, at least one free end and an opening that extends from the upper surface to the lower surface and is spaced apart from the fixed end and from the at least one free end; and
a condiment holder defined by a bottom and a plurality of sides, each of the plurality of sides extending from the bottom of the condiment holder to a top end of the condiment holder; and
wherein the opening in the condiment flap of the snack holder receives and holds the condiment holder so that a first portion of the condiment holder is protruding substantially upward from the upper surface of the condiment flap and a second portion of the condiment holder is protruding substantially downward from the lower surface of the condiment flap.

2. The snack tray assembly of claim 1, wherein the snack holder comprises a single, continuous piece of sheet material.

3. The snack tray assembly of claim 2, wherein the plurality of sides of the receptacle comprise a back panel, a front panel, a first side panel and a second side panel.

4. The snack tray assembly of claim 2, wherein the single, continuous piece of sheet material comprises:
a first free edge;
a first score spaced apart from and substantially parallel with the first free edge such that the first free edge and the first score define the back panel of the receptacle;
a second score spaced apart from and substantially parallel with the first score such that the first score and the second score define the first side panel of the receptacle;
a third score spaced apart from and substantially parallel with the second score such that the second score and the third score define the front panel of the receptacle;
a fourth score spaced apart from and substantially parallel with the third score such that the third score and the fourth score define a second side panel of the receptacle; and
a top score substantially perpendicular to the first, the second, the third and the fourth scores and the first free edge, wherein the top score defines a top end of one of the back panel, the front panel, the first side panel and the second side panel of the receptacle.

5. The snack tray assembly of claim 4, wherein the single, continuous piece of sheet material further comprises a second free edge spaced apart from the fourth score such that the fourth score and the second free edge define a glue flap, wherein the glue flap is adhesively coupled to the back panel to place the second side panel adjacent to the back panel when the receptacle is formed.

6. The snack tray assembly of claim 4, wherein the top score defines a top end of the first side panel of the receptacle.

7. The snack tray assembly of claim 6, wherein a top end of the back panel and a top end of the front panel comprise free edges that are out of alignment with the top score and out of alignment with a top end of the second side panel.

8. The snack tray assembly of claim 7, wherein a midpoint of the top end of the front panel of the receptacle and a midpoint of the top end of the back panel of the receptacle comprise a height relative to the bottom of the receptacle that is less than a height of the top score and the top end of the second side panel relative to the bottom of the receptacle.

9. The snack tray assembly of claim 1, wherein the condiment holder comprises a single, continuous piece of sheet material.

10. The snack tray assembly of claim 9, wherein the bottom of the condiment holder comprises a first bottom panel and a second bottom panel and the plurality of sides of the condiment holder comprise a first side panel having a first free top end, a second side panel having the first free top end, a third side panel having a second free top end and a fourth side panel having the second free top end.

11. The snack tray assembly of claim 10, wherein the single, continuous piece of sheet material of the condiment holder comprises:
a first score coupling the first bottom panel to the second bottom panel;
a second score coupling the first side panel to the first bottom panel;
a third score coupling the second side panel to the first bottom panel;
a fourth score coupling the third side panel to the second bottom panel; and
a fifth score coupling the fourth side panel to the second bottom panel; and
wherein the first score, the second score and third score define the first bottom panel and the first score, the fourth score and the fifth score define the second bottom panel.

12. The snack tray assembly of claim 11, wherein the single, continuous piece of sheet material of the condiment holder further comprises:
a sixth score coupling the first side panel to the second side panel;
a seventh score coupling the third side panel to the fourth side panel;
an eighth score coupling the first side panel to a first glue flap; and
a ninth score coupling the second side panel to a second glue flap; and
wherein the first glue flap adhesively couples to the third side panel to place the first side panel adjacent to the third side panel when the condiment holder is formed and wherein the second glue flap adhesively couples to the fourth side panel to place the second side panel adjacent to the fourth side panel when the condiment holder is formed.

13. A snack tray assembly comprising:
a first sheet material formable into a primary container, the first sheet material comprising:
a first bend spaced apart from a first free edge such that the first free edge and the first bend define a back panel;
a second bend spaced apart from the first bend such that the first bend and the second bend define a first side panel;
a third bend spaced apart from the second bend such that the second bend and the third bend define a front panel;
a fourth bend spaced apart from the third bend such that the third bend and the fourth bend define a second side panel;
a support panel coupled to one of the back panel, the front panel, the first side panel and the second side panel by a top bend that defines a top of one of the back panel, the front panel, the first side panel and the second side panel, wherein the support panel comprises a through hole; and
a second sheet material formable into a secondary container, the secondary container being partially inserted into and held in the through hole in the support panel of the first sheet material.

14. The snack tray assembly of claim 13, wherein the second sheet material comprises a first bottom panel, a second bottom panel, a first side panel having a first free top end, a second side panel having the first free top end, a third side panel having a second free top end and a fourth side panel having the second free top end.

15. The snack tray assembly of claim 14, wherein the second sheet material further comprises:
a first bend coupling the first bottom panel to the second bottom panel;
a second bend coupling the first side panel of the second sheet material to the first bottom panel;
a third bend coupling the second side panel of the second sheet material to the first bottom panel;
a fourth bend coupling the third side panel to the second bottom panel; and
a fifth bend coupling the fourth side panel to the second bottom panel; and
wherein the first bend, the second bend and third bend define the first bottom panel and the first bend, the fourth bend and the fifth bend define the second bottom panel.

16. The snack tray assembly of claim 15, wherein the second sheet material further comprises:
a sixth bend coupling the first side panel of the second sheet material to the second side panel of the second sheet material;
a seventh bend coupling the third side panel to the fourth side panel;
an eighth bend coupling the first side panel of the second sheet material to a first glue flap; and
a ninth bend coupling the second side panel of the second sheet of material to a second glue flap; and
wherein the first glue flap adhesively couples to the third side panel to place the first side panel of the second sheet of material adjacent to the third side panel when the condiment holder is formed and wherein the second glue flap adhesively couples to the fourth side panel to place the second side panel of the second sheet material adjacent to the fourth side panel when the condiment holder is formed.

17. The snack tray assembly of claim 15, wherein the first bottom panel, the second bottom panel and lower portions of the first side panel of the second sheet material, the second side panel of the second sheet material, the third side panel and the fourth side panel are located below the support panel when the condiment holder is located in the through hole and wherein upper portions of the first side panel of the second sheet material, the second side panel of the second sheet material, the third side panel and the fourth side panel are located above the support panel when the condiment holder is located in the through hole.

18. A method of assembling a snack tray comprising:
forming a first sheet material into a snack holder having a receptacle and a condiment flap, wherein the receptacle is defined by a bottom and a plurality of sides that extend from the bottom of the receptacle to a top of the receptacle and wherein the condiment flap includes an upper surface, an opposing lower surface, a fixed end coupled to the top of one of the plurality of sides, at least one free end and an opening that extends from the upper surface to the lower surface and is spaced apart from the fixed end and from the at least one free end;
forming a second sheet material into a condiment holder; and
inserting the condiment holder into the opening in the condiment flap of the snack holder so that a first portion of the condiment holder is protruding substantially upward from the upper surface of the condiment flap and a second portion of the condiment holder is protruding substantially downward from the lower surface of the condiment flap.

19. The method of claim 18, wherein forming the first sheet material into the snack holder comprises bending and adhering portions of the first sheet material to form the bottom and the plurality of sides of the receptacle and to form the condiment flap.

20. The method of claim 19, wherein forming the second sheet material into a condiment holder comprises bending and adhering portions of the second sheet material to form a bottom and a plurality of sides of the condiment holder.
